(19) United States
(12) Patent Application Publication
(10) Pub. No.: US 2004/0254846 A1
(43) Pub. Date: Dec. 16, 2004

(54) Options for negotiation with multiple sellers

(76) Inventor: Andrew Robert Byde, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/461,606

(22) Filed: Jun. 13, 2003

(51) Int. Cl. G06F 17/60

(52) U.S. Cl. 705/26

(57) ABSTRACT

An automated negotiation system and an automated negotiating method involve a processor adapted to, on identifying a plurality of sellers for a quantity of a good or service, create a plurality of permutations each comprising an ordering of the sellers in the plurality of sellers. For each of the permutations, an allocation of the quantity between the sellers is created wherein as much is allocated to the first seller in the ordering as can be sold by that seller and consequently as much of the remainder is allocated to the second seller in the ordering as can be sold by that seller and so on for each subsequent seller until all the quantity has been allocated, each such allocation creating a bundle for that permutation. Negotiation takes place with at least some of the plurality of sellers in order to buy one of said bundles.

### FIELD OF THE INVENTION

The invention relates to methods and apparatus for automated negotiation, specifically for negotiation with multiple sellers for a good or service.

### DESCRIPTION OF PRIOR ART

If a user wishes to purchase a quantity of a good, for example over the public Internet, a variety of options are currently available. These include electronic auctions (e-auctions) and direct sales channels, either offering fixed price goods and services or allowing for the possibility of negotiation.

It is difficult to exploit such a range of resources efficiently. This task is further complicated when the purchaser is presented with a number of sellers, each of whom is selling goods at a wide range of quantities, and the purchaser needs to purchase a large quantity of goods, necessarily split between several sellers. The problem of finding the optimal assignment of quantities to sellers (hereafter termed a “bundle”) is now generally very difficult. While it will always be theoretically possible to enumerate and evaluate every possible option, this may be too inefficient and computationally expensive (or slow) a process to contemplate.

### SUMMARY OF THE INVENTION

Accordingly, in a first aspect the invention provides a method of automatic negotiation with multiple sellers for a first quantity of a good or service, the method comprising: identifying a plurality of sellers offering quantities of the good or service; automatically creating a plurality of permutations each comprising an ordering of the sellers in the plurality of sellers; for each said permutation, automatically performing the substeps of initialising a cumulative total, allocating to the first seller in the permutation a whole of the quantity offered by that seller or a part of the quantity sufficient to make the cumulative total equal to the first quantity, adding the quantity allocated to the first seller to the cumulative total, and continuing said allocating and adding substeps for each successive seller in the permutation until the cumulative total is equal to the first quantity, whereupon the allocation of quantities of the good or service to each seller in the permutation forms a bundle for that permutation; and negotiating with at least one of said plurality of sellers in order to buy one of the bundles.

In a further aspect, the invention provides an automated negotiation system, comprising a processor and a communications interface, wherein the processor is programmed to on identifying a plurality of sellers for a quantity of a good or service, create a plurality of permutations each comprising an ordering of the sellers in the plurality of sellers; for each of the permutations, create an allocation of the quantity between the sellers wherein as much is allocated to the first seller in the ordering as can be sold by that seller and consequently as much of the remainder is allocated to the second seller in the ordering as can be sold by that seller and so on for each subsequent seller until all the quantity has been allocated, each such allocation creating a bundle for that permutation, wherein the processor is adapted to negotiate through the communications interface with at least some of the plurality of sellers in order to buy one of said bundles.

In a still further aspect, the invention provides a data carrier having recorded thereon program code which when executed by a processor, causes the processor to negotiate for a quantity of a good or service with an identified plurality of sellers for said good or service by creating a plurality of permutations each comprising an ordering of the sellers in the plurality of sellers; for each of the permutations, creating an allocation of the quantity between the sellers wherein as much is allocated to the first seller in the ordering as can be sold by that seller and consequently as much of the remainder is allocated to the second seller in the ordering as can be sold by that seller and so on for each subsequent seller until all the quantity has been allocated, each such allocation creating a bundle for that permutation, and negotiating with at least some of the plurality of sellers in order to buy one of said bundles.

In a yet further aspect, the invention provides a signal having data encoded thereon comprising program code which when executed by a processor, causes the processor to negotiate for a quantity of a good or service with an identified plurality of sellers for said good or service by creating a plurality of permutations each comprising an ordering of the sellers in the plurality of sellers; for each of the permutations, creating an allocation of the quantity between the sellers wherein as much is allocated to the first seller in the ordering as can be sold by that seller and consequently as much of the remainder is allocated to the second seller in the ordering as can be sold by that seller and so on for each subsequent seller until all the quantity has been allocated, each such allocation creating a bundle for that permutation, and negotiating with at least some of the plurality of sellers in order to buy one of said bundles.

### BRIEF DESCRIPTION OF DRAWINGS

Embodiments of the invention will now be described by way of example only, with reference to the drawings in which:

FIG. 1 is a schematic block diagram of a computerised system employing apparatus adapted for automated negotiation and suitable for use with embodiments of the invention;

FIG. 2 is a block flow diagram showing the main operational steps that occur in or in association with a coordination module of the computerised system of FIG. 1;

FIG. 3 is a schematic description of the processes operating in the computerised system of FIG. 1; and

FIG. 4 is a block flow diagram showing the main operational steps that occur in or in association with an agent of a computerised system according to FIG. 1 engaged in negotiation.

### SPECIFIC EMBODIMENTS OF INVENTION

A preferred embodiment will now be described in the context of a system for allowing a buyer to negotiate automatically with a plurality of sellers, the system being particularly suited to participation in a number of a number of negotiations with direct sellers together with a number of electronic auctions conducted over the Internet (or other appropriate communication medium). It will be appreciated from the discussion below that the invention has broader application than to the specific system described here, which however demonstrates practical benefits that follow from use of the invention.

System Overview

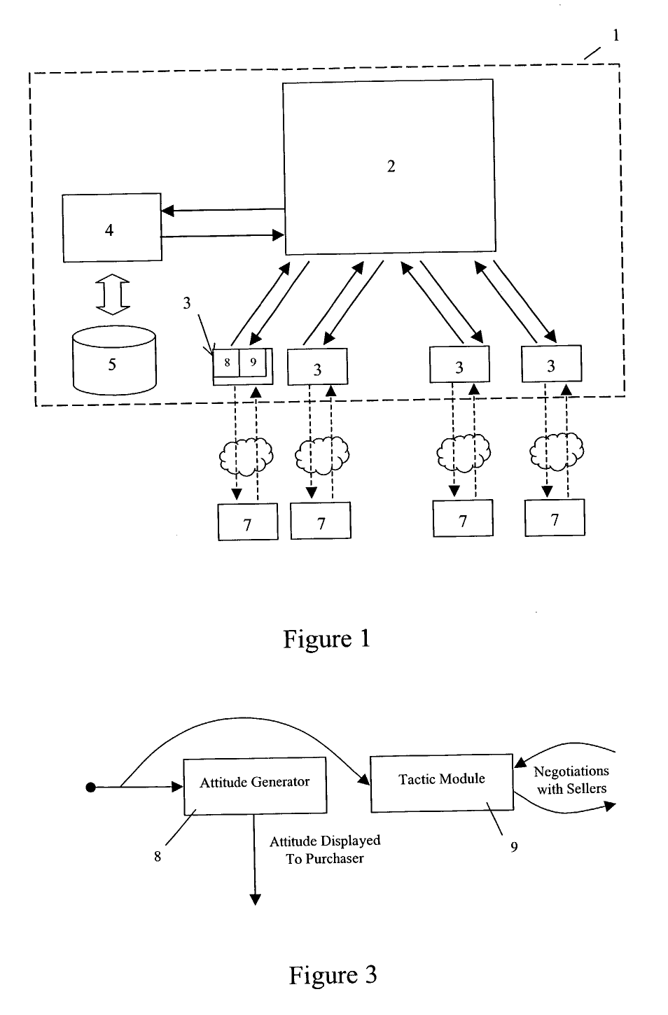

With reference to FIG. 1, a computerised system 1 for allowing a buyer to negotiate with a plurality of sellers is shown. The system 1 deploys a set of automated negotiating agents 3, each of which is engagable with a seller or source of goods—examples of such sources may be an electronic auction (e-auction) or electronic negotiation 7 with a direct seller conducted over the Internet or other communication means. One negotiation agent 3 shown here comprises an attitude generator 8 and a tactic module 9—the significance of these will be described further below (from which it will also be clear that agents engaging only with auctions need not have such features). The computerised system 1 comprises a coordination module 2 for ensuring the set of negotiating agents 3 interact effectively. These agents may, for example, be separate processes also resident on the same computational apparatus as for the coordinating module—it is also possible for the computerised system 1 to be distributed over different computing apparatus, provided that such communications between the different elements as are necessary can be maintained. It also comprises linked to the coordination module 2 a belief module 4 and an associated history data store 5 for storing history data relating to past trading prices. The system monitors various e-auctions and one-to-one negotiations and maintains historic data on the outcome in the history data store 5, the system using such historic data and the belief module 4 to predict the spread of expected performance of each of the possible negotiations/auctions in which it may need to participate. The coordination module 2 allows the negotiation process to be automated in a principled, economic fashion.

As will be appreciated, this system can be implemented on conventional computing apparatus with all the normal features thereof—it can either be implemented on an autonomous user computer (such as a personal computer) or on a server accessed by a user by means of a network connection from a user computer. The presence of conventional features of computing apparatus (processor, memory, user interface such as keyboard and display, network connections) is therefore assumed. It will further be appreciated that the key functional elements of this system may all be achieved by conventional processors with appropriate memory and network connections programmed with suitable software, aspects of the invention extending to the provision of such software on data carriers or as information signals or by any other appropriate means.

Process Overview

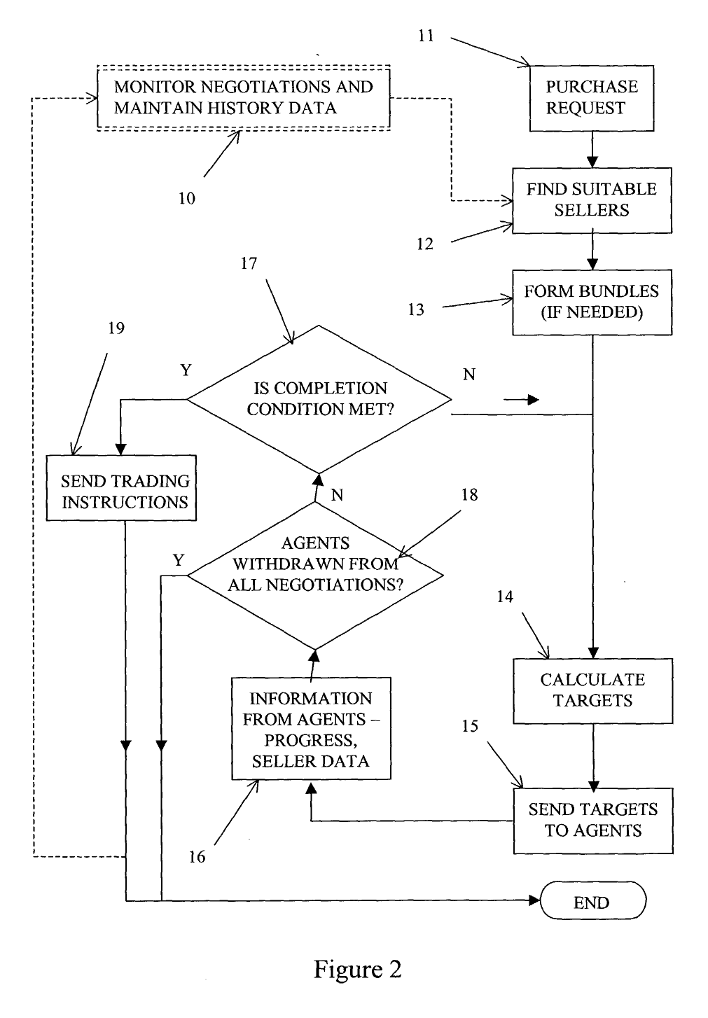

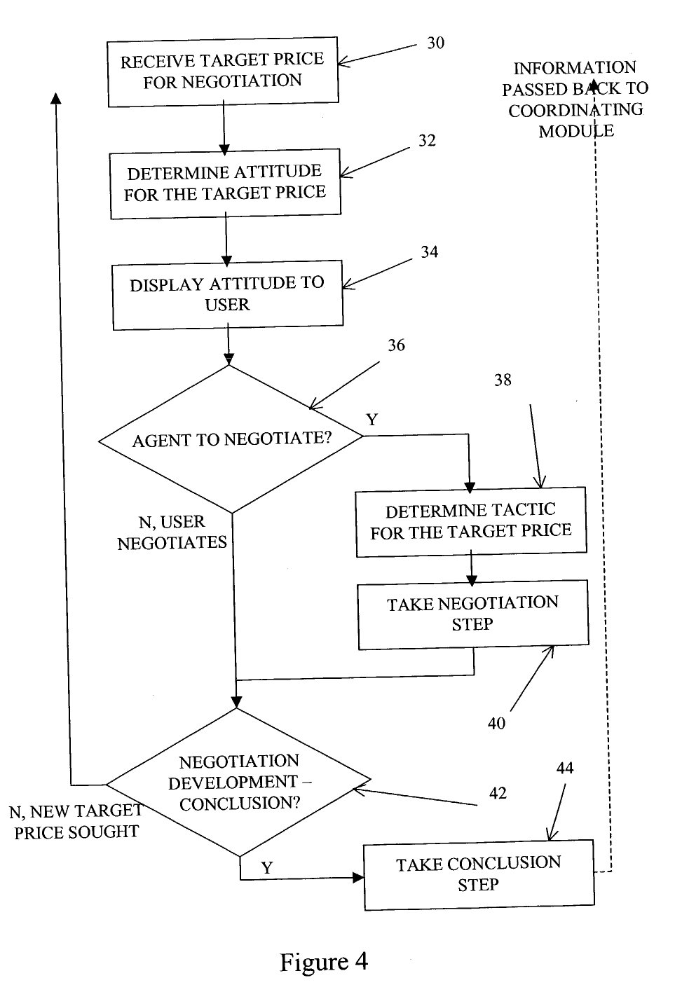

To help describe the mode of operation of the system, reference is made to FIG. 2 (which is based around the activity carried out or directly controlled by the coordinating module 2) and FIG. 4 (which relates to the activity carried out by an agent 3). The coordinating module monitors various e-auctions and one-to-one negotiations and maintains history data relating to past trading prices in step 10, indicated here with a dashed line to represent background to any specific negotiation. The coordinating module will use this history data to predict the spread of expected performance of each of the possible negotiations/auctions associated with a specific transaction.

When the purchaser (who is the user) wishes to make a purchase, they enter a purchase request 11 detailing their requirements and a list of potential auctioneers and/or suppliers into the system via a user input interface, such as a keyboard, for example. On the basis of this information together with information gathered by the system on the current state of negotiations, the system is able to find suitable sellers 12.

There may be different ways to meet the purchase request from different sellers. The negotiation coordinating module 2 bases its decisions on the state of all negotiations, and on beliefs regarding likely outcomes of those negotiations, generated from historical data. The negotiation coordinating module 2 evaluates potential purchases (complete specifications of all flexible parameters, such as quantity and delivery date), preferably all such potential purchases, from each seller, and selects the best set of possible alternative purchases to satisfy the user's purchase requirement (such a set is termed a set of purchase bundles) from which the target prices for the negotiation agents 3 are generated. The computing system thus sets a target price 14 for each potential transaction.

The target price is then sent to the corresponding negotiating agent (step 15 in FIG. 2, step 30 in FIG. 4) involved in attempting to make a transaction by negotiating (with a direct seller) or bidding (in an auction) to reach that target.

In the case of negotiation, the attitude generator 8 and the tactic module 9 may be employed. The relationship between the negotiation coordinating module 1 and the attitude generator 8 and the tactic module 9 of an agent 3 is illustrated in FIG. 3. The target price generated by the coordination engine 2 is sent to the attitude generator 8 which determines an attitude for the target price which is then displayed to the purchaser. The attitude consists of two parts; the first part contains information about the long-term viability of the particular trading option; the second part contains information about the immediate viability of the particular trading option. A formal definition of attitude is given further below. Optionally, the target price sent by the coordination engine 2 may be provided to the tactic module 9 for selection of a tactic to be used in negotiations with the seller.

Continuing to consider negotiation, the attitude for a particular trading option (purchase) is determined 32 and then displayed to the purchaser in natural language text 34. The option may then be available 36 for the purchaser to negotiate directly or by means of the agent 3. If the purchaser is to negotiate, the purchaser can use the attitude information to adjust their behaviour accordingly in their negotiations for that purchase. Instead of the purchaser using the attitudes to adjust their behaviour in direct negotiations, the purchaser can opt to use the negotiation agents 3 to conduct negotiations for the desired trading options (in the detailed description that follows, it will be assumed that this is the approach taken for all negotiations). In this instance, each negotiation agent 3 will select 38 a suitable tactic to be used in the negotiations for the associated trading option, consisting of a rule that generates new counter-offers in response to offers from the seller, in the context of the current state of the negotiation. The tactics are derived from the target prices as explained later, using the equations given further below. The negotiation agent then makes an appropriate negotiation step 40.

As negotiations progress, the system receives updated data on the sellers (sent by the negotiating agents 3 in step 42, see FIG. 4) and updated information from the negotiating agents regarding the state of negotiation 16 (FIG. 2, referred to for following steps), which the system uses to modify the expected performance of each negotiation accordingly. The system will also be updated with the results, or current positions, in auctions—whether a negotiating agent participating in an auction has managed to purchase an item in an auction (at or below a target price) or whether the auction has progressed to a point where this is no longer possible (or if the expected selling price in the auction has changed—likely to be the case for any auction that has approached a previously expected selling price) The system then recalculates the target 14 for each negotiation in response to these modified expectations and any successfully completed negotiations, i.e. successful purchases. The negotiations continue until the completion conditions have been met 17, at which point trading instructions are sent to the corresponding negotiating agent which then waits for the finish 19, or until the negotiating agents have been forced to withdraw from all negotiations 18. Note that information about the progress of the negotiations and their conclusions is used by the coordinating module 2 to update the history data store 5.

The targets are the mechanism through which coordination is possible, as they are sent to the negotiating agents which then determine what action to undertake as a consequence. Specific aspects of the operation of the system will now be described in more detail.

History Data, Beliefs and Expected Prices

History data is accumulated for past trading conducted over a period of time, which enables a knowledge base to be built up containing information on the prices to expect when trading with certain business entities for particular goods relative to the market prices, and which is dependent on the quantities involved. The belief module associated with the knowledge base provides an interface for the coordination module through which it can interrogate the knowledge base for data on past prices that an auction/seller has agreed to, in connection with particular quantities of certain goods. The belief module uses this history data to answer the query: What is the probability that price x would be acceptable as a final purchase price to an auction/seller y for goods z? The answer provided by the belief module is a probability of a price being accepted that is equal to the proportion of all trades that have occurred at the price x or at a price lower than x. The answer returned by the belief module to the coordination module is a ‘belief’, a measurement or estimate of the likelihood that the auction/seller y will settle at or below price x.

For the purposes of this specification a seller is an entity with which a purchaser may trade, through the coordination module. A seller may be, for example, an e-auction or a direct seller—it may be appropriate to employ different calculations for auction sellers and direct sellers, as can be seen below.

If a seller has never been encountered before, then the belief module will not be able to answer a query relating to that trader, and the system will have no idea of what sort of price that seller may trade at. The system should, to enable satisfactory engagement will all potential sellers, possess some means of assuming the likely prices at which a seller might trade. In the absence of any data being held in the knowledge base relating to a particular seller, the belief module can therefore derive the likelihood of a given price being acceptable to that seller from observation of the market. Alternative methods of deriving a likely price are by observing the seller's trading behaviour with respect to other traders, and by looking at posted prices and how those change with time for a given trader.

A preferred technique for deriving a likely price that will be acceptable for the seller is to base it on experience. The reason for this is although there will be data from which an answer to a query can be formulated, it can not be presumed that the likely prices derived from observations will be applicable to the purchaser presently in question. This is because in the business world, sellers often offer different trading entities different prices for the same goods. The price the purchaser can negotiate with the seller depends on the beliefs held by each about the other. Prices are calculated using beliefs about the various sellers and options involved.

A set of options is allocated to each seller. An option is defined by the seller seller (o) to which it belongs, and fixed values for quantity denoted quantity (o), or q(o). It is assumed in the following discussion that auctions sell fixed quantities which the purchaser buys either all or none of, and it follows that each auction seller has a unique option (as will be appreciated, the calculations that apply if these assumptions cannot be made are more complex—however, application of the present invention does not necessarily require these assumptions to be true). Each option has a range of prices (per unit) associated to different choices of a risk parameter. The possible values for the option risk parameter are:

best price (best case), p₋(o)

expected price (average case), Pₑ(o)

no-risk price (worst case), p₊(o)

and the set of options that is associated to a given seller S is written as option(S).

A ‘belief’ is a probability distribution over prices per unit, parametrized by the properties that an ‘option’ may have, and generated from history data. In the case where quantity is the only property an option may have, a function bₛ(p,q) is associated with each seller, with the interpretation that the probability of the price for the option oεoption (S) closing between prices p₁ and p₂ (per unit) is believed, prior to the start of negotiations to be:

∫ₚ_{₁}^{p}^{₂}bₛ(p,quantity(o))dp.

It is assumed that for auctions, beliefs are constant with respect to the quantity parameter.

The best price p₋(o) of an option o is defined as follows.

For auctions, p₋(o) is the currently posted winning bid if the purchaser holds the winning bid, or the minimum bid that the purchaser would need to place to obtain the leading bid, otherwise.

For direct sellers, p₋(o) is the current highest offer that the purchaser has made for the specified option, or some fixed minimum, pₘᵢₙ(o) otherwise.

The no-risk price p₊(o) of an option o is the larger of the best price and the largest number p such that for all p′<p,

∫ₚ_{^{′}}^{∞}bₛ(p,quantity(o))dp>0

Informally, it is the highest price to which the purchaser attaches non-zero probability (via the belief).

Given an option oεoption (S), associated belief bₛ(p,q), best price p₋(o), and no-risk price p₊(o), the expected (likely) price of the option o is given as:

$${p}_{e} ( o ) = \frac{( {\int }_{{p}_{-} ( o )}^{{p}_{+} ( o )} {pb}_{S} ( p , q ( o ) ) ⅆ p )}{( {\int }_{{p}_{-} ( o )}^{{p}_{+} ( o )} {b}_{S} ( p , q ( o ) ) ⅆ p )} . \qquad ( 1 )$$

Meeting a Purchase Request

The coordination module 2 uses the beliefs from the belief module 4 to return the likelihood of a given price being acceptable to the other party, and ensures that the set of negotiating agents 3 interact effectively, for example in the case where a given purchase request may be too large for a single trader (seller) to supply. Here the purchase request will need to be divided between multiple sellers, and there may be many different ways of dividing the purchase request amongst the sellers depending on the capacity of each seller and the units of quantity they are willing to supply, amongst other things. To illustrate this point, consider that a purchase request is made for 9,800 tonnes of cement, and there are individual sellers who are willing to supply cement in multiples of 5,000 tonnes, but who are too big a trader to bother with any unit less than 5,000 tonnes. Consider, also, that there are other sellers who are willing to supply in smaller units of quantity, but will ask for a higher price because there is no bulk discount to be given for these smaller quantities. Therefore, there are clearly many different ways in which the quantity of cement can be subdivided or sub-quantified. Associations of sub-quantity to each potential seller that constitute the purchase request is termed a ‘bundle’, and there may be many potential bundles that need to be considered as worth pursuing by the coordination module 2 in order to fulfil the purchase request.

A bundle is a set of options, and just like options, bundles have a quantity and a range of prices associated to them. For each bundle b, the quantity of that bundle is defined as the sum of the quantities of the bundle's constituent options. The possible values for the bundle risk parameter and corresponding (total) prices for a bundle b are:

Best price, p₋(b)

Expected price, pₑ(b)

Auction-only price, pₐ(b)

No-risk price, p₊(b)

For each bundle risk parameter other than auction-only, the price of a bundle b is defined to be the sum over the constituent options o in b of the corresponding price for that option. The auction-only price of a bundle b is defined to be the sum over all options in b which belong to an auction, of the expected price of that option, plus the sum over all options in b which belong to a direct seller, of the no-risk price of that option. For a collection of M of bundles, and a choice of bundle risk parameter, the best price of M is set to be the minimum over bεM of the price of b; best is similarly subscript to p.

As there may be many potential bundles that may be pursued to fulfil the purchase request, the issue that needs to be addressed is what position should be taken with each seller given the multitude of options there are.

This issue is addressed by having the coordination module 2 calculate targets for each option, which are calculated with reference to the other sellers and the options they offer. The target for a quantity from a seller is the maximum price that the purchaser can afford to pay, given the other prices on the other sub-quantities constituting the bundle so that the bundle would still be the best (lowest priced) bundle available. The target of option o can be intuitively understood to be the maximum price per unit likely to be acceptable for o, and is calculated using a type of “credible threat” reasoning: it worth considering o at price p only if there is a completion of o to a bundle no more expensive than the best bundle available not including options belonging to S. This understanding is modified by risk-parameters that capture “best-case”/“average-case”/“worst-case” qualifications of the above clauses. Thus for each option o, and some set of potential purchase bundles M, known as the Maximisation Set, the following definitions are given.

The set of alternatives are those purchase bundles which do not contain any options belonging to the seller S of o:

M_{S}^{a}={bεM:options(S)∩b=0}.

The set of completions are those bundles which, with o added, become an acceptable purchase bundle:

Mₒ^{c}={bεB:o∉b,{o}∪bεM}.

The target of o relative to the set of purchase bundles M is defined for any pair of bundle-risk preferences, r₁, r₂ε{−,e,a,+}, as:

$${t}_{{r}_{1} , {r}_{2}}^{M} ( o ) = ( {best}_{{r}_{1}} ( {M}_{seller ( o )}^{a} ) - {best}_{{r}_{2}} ( {M}_{o}^{c} ) ) / q ( o ) .$$

(in other words, r1 relates to the best, expected, etc. price of the set of alternatives, whereas r2 relates to the price of the set of completions)

The possible practical implementations of the coordination module 2 will differ principally on the Maximisation Set M of bundles that are taken into consideration when setting targets. The set of “all acceptable purchase bundles” is:

M_{Q,P}={bεB:p₋(b)≦P,quantity(b)=Q},

whereby the bundle's quantity is required to be exactly Q so that M_{Q,P} may be empty. Note that when there are several direct sellers, the set M_{Q,P} may be too large to store in the system, let alone to calculate over, so it is necessary to provide restricted sets of bundles over which to reason.

An algorithm which delivers a maximization set which is tractable for a small number (<10-15) of sellers is described below, and uses the basic idea that for each ordering of sellers, one can attempt to assign (allocate) as much as possible of the full quantity to the first seller (without exceeding the required amount), then as much as possible of the remaining amount to the second supplier, and so on until the amount is exhausted. The algorithm presents a way of doing this which, by appropriate cutting of the procedure to generate all orderings of the sellers, considerably reduces the average computation time.

Suppose that there are n sellers, S=s₁, . . . , sₙ.

Let Sₙ be the set of all permutations on n objects, i.e. if σεSₙ then σ maps each of the numbers 1, . . . , n to a number in the same range with no overlaps: there are no two numbers on which σ takes the same value.

The set of permutation-based bundles Mₚₑᵣₘ is produced as follows:

For each element σ of Sₙ,

1. Construct a list of quantities q by setting, for each I=1, . . . , n, q_{σ(i)} to be the maximum quantity possible for seller s_{σ(i)} that is also less than Q minus the total quantity allocated so far:

$${q}_{σ ( i )} \leq Q - {\sum }_{j = 1}^{i - 1} {q}_{σ ( j )} ,$$

or zero if no such quantity exists.

2. Construct a bundle b_{σ} by including, for each i, an option for seller sᵢ at quantity qᵢ (if qᵢ>0).

3. Add the bundle b_{σ} to Mₚₑᵣₘ unless it is already present.

This algorithm generates all acceptable purchase bundles in the case where all the sellers are auctions. In the case of direct sellers, it may not generate every possible bundle for some price functions, but should generate most potentially useful ones. In both cases, pruning then has to be done on the basis of the maximum price P that the purchaser is prepared to pay.

A practical recursive implementation of the above-described algorithm is given as follows:

1. Define a list of bundles Mₚₑᵣₘ, initialised to be empty.

2. Define a set of quantities qᵢ, initialised to be zero, and an array of booleans bᵢ initialised to false.

3. Invoke the following psuedo-code recursive algorithm, SCAN(q), on q=Q:

```
SCAN(q):
If q=0; convert the list of quantities into a bundle; return.
For each j such that bⱼ is false {
    Let qⱼ be the largest quantity ≦ q that seller j offers
    If qⱼ > o {
        set bⱼ=true
        call SCAN(q−qⱼ)
        set bⱼ=false
        set qⱼ=0
    }
}
```

It can be noted that the approach described above is useful in a wide range of situations—for example, it can be applied if the available sellers are direct sellers only, are auctions only, or provide any mix of the two.

If all the potential ways of fulfilling the purchase request are investigated, as well as the expected price of each, a cheapest bundle will be found which will be the best bundle. Then, for a given option, if the price is low enough, it may be that this option and some other collection of sellers added to it will be the best bundle, but only if the price is low enough. The target is the cut-off point below which the given option for this seller with this quantity of goods, becomes an attractive prospect, as it is expected that this will be the best bundle that can be had.

Essentially the target is equal to the minimisation over one set of bundles of a likely price, minus a minimisation of the completions of a given option. So for a given option the coordination module will evaluate the potential completion costs and then subtract these from the likely price to calculate a target. However, the target will depend on the purchaser's attitude to risk, as described below.

Expected price has already been defined above (see equation 1), but is now explained in the context of use with the system for a given quantity from a given seller. The coordination module does not know what price will be eventually settled with the seller for the given quantity of goods. However, on querying the belief module, the coordination module receives the likelihood, i.e. the probability, of each potential price being that established with the seller, which can be used to calculate the expected price by summing over all the potential prices of that price multiplied by the likelihood of that price being the one that will be accepted.

The expected price provides the coordination module with a measure of what to expect as the price for a given quantity from the seller, but it must be remembered that this measure is derived from taking a flat average, and different purchasers have have (or have had) different attitudes to risk. Hence, there are many different ways of taking the beliefs generated by the belief module and using them to derive expected prices, depending on the attitude of the purchaser. For example, taking the viewpoint of a risk-averse purchaser who does not want to entertain risks, although the expected price could be any one of the best-case, average-case or worst-case prices, the purchaser will assume the worst-case price (which will be the most expensive). Conversely, the purchaser may be optimistic, and although the expected price could be any one of the best-case, average-case or worst-case prices, the view of the purchaser is to assume the lowest price, i.e. the best-case price. Thus, there are different ways of using the belief module to derive the expected (likely) price on the basis of the purchaser's attitude to risk. For each different way of generating the prices, the coordination module can be programmed to calculate the expected price for the best-case, average-case and worst-case differently, and therefore a number of different targets can be derived. Hence for different possible choices of risk, the coordination module will evaluate different targets.

Negotiation and Bidding Process—Options to Pursue

When negotiating with a direct seller S, there may be many options with respect to which negotiation could proceed. In the approach discussed here, the options are ordered according to the best expected price amongst acceptable purchase bundles containing them.

The best bundle with respect to risk option χ, B_{χ} is any bundle b in the maximization set such that p_{χ}(b)=best_{χ}(M). It is assumed that there is an implicit total ordering on bundles which allows B to be selected consistently and un-ambiguously.

If Bₑ∩options(S)≠0, then the option o which forms the intersection is the most favoured option for seller S. Otherwise, o is the smallest-quantity option which minimizes the expected price function over bundles containing an option from the given seller:

q(o)pₑ(o)+bestₑ(Mₒ^{c})=bestₑ(M\M_{S}^{a}).

Once targets have been established, the approach taken by a negotiation agent 3 depends on whether it is participating in an auction, or whether it is negotiating with a direct seller. The two approaches to be followed are very different.

When participating in an auction, the logic for a negotiation agent 3 responsible for an auction with option o is in this embodiment simple: whenever not holding the active bid, and whenever the price of the active bid would be lower than the full-risk, no-risk target t_{e,e}(o), (expected price for alternatives, expected price for completions) the agent 3 should bid. Other rules could of course be chosen here, such as bidding if and only if the price is less than any one of the other targets (e.g. t_{+,-}(o)).lt is assumed here that participant information is hidden in the auction process, in which case there is no significant strategic aspect to bidding except deciding how high to go. More complicated strategic scenarios (e.g. ones in which identities are revealed, or there are last-minute bidding effects), are not considered in respect of this embodiment, but could be addressed in other implementations of this invention. It should further be appreciated that if the auction parameters are such that there can be a strategic aspect to bidding, then the general approach to attitude and tactics discussed here in respect of negotiation with direct sellers may be applied in principle, with appropriate practical modifications to address the structure of the auction concerned.

For coordination engines working with direct sellers, a different approach is required—interaction with the seller is not constrained in the way it is for the auction case, and there is a benefit from taking a strategic approach. A structure is also needed for the negotiation—here it is assumed that a first message sent is a Request for Quote to fulfil the purchase request. After the seller's reply, the negotiation agent 3 and the seller take turns in submitting offers to each other. The first bid that is sent in response to the seller's reply to the Request for Quote may also be customised, with an appropriate default being to send pₘᵢₙ.

As one of the strategies to be used when negotiating one-to-one with multiple sellers, the negotiation agent 3 can effectively simulate a process of reverse auction. If a certain pre-defined predicate is true, the agent 3 will play the sellers against one another by broadcasting an ultimatum to beat price t_{+,+}(o) (no risk price for alternatives bundle, no risk price for completions bundle). This predicate will be defined over the properties of the purchase request and can be customised. A suitable choice is “Q>Qₒ”, for some fixed value Qₒ.

It is important to note that this step need not be fixed for the whole course of the negotiation at the beginning of the negotiation. This process (of selecting the best options to pursue) may be started afresh when information is received from the agents 3 concerning the state of current negotiations.

Negotiation Process—Attitude

During direct negotiations the negotiation agent's reasoning process for deciding how to negotiate will be in two stages: on the basis of a given set of inputs that describes the state of the world in which the coordination engine 2 finds itself, it will provide:

1. A summary of the purchaser's position, and its expectations for the future of this negotiation. This is known as its attitude.

2. A rule for generating new messages to advise the seller (or to the negotiating agents negotiating part) on the basis of old messages and on the current status of the negotiation. This is known as its tactic.

The attitudes that a purchaser holds in a direct negotiation should, preferably, reflect the long-term, high-level strategy to be pursued with respect to the seller in question. Preferably, they should be readable and interpretable by a non-expert human.

The key input to provide attitudes and tactics is the target price (note that in this arrangement the attitude and tactics do not depend on each other—however, some of the same inputs are used to generate both). While embodiments could be used with a single target price for each negotiation, preferred arrangements use a vector of target prices indexed by variables representing various risk possibilities (best-case, expected-case, worst-case).

Presently, an option-attitude is defined for each option o the sellers offers, as a pair of descriptions selected according to the following rules.

| | | |
|---|---|---|
| descr. 1 = | if pₑ(o) > t_{+,e}(o) | “Forget about it: |
| | | Extremely unlikely to trade” |
| else | if pₑ(o) > t_{e,e}(o) | “Pull up your socks: |
| | | Unlikely to trade eventually” |
| else | | “Hope to trade eventually” |

This first description describes the overall expectations for this negotiation. In the first case, the expected price of the option is such that if added to the expected price set for completions in the target the result exceeds the no-risk price in the target for the alternatives (making it singularly unlikely that this option could result in the best deal). The intermediate case is more hopeful—the expected price of the option is such that if added to the expected price set for completions in the target the result exceeds the expected price (but not the no-risk price) in the target for the alternatives—but is not likely to be the best current candidate for success. In the third case, the expected price of the option is such that if added to the expected price set for completions in the target the result will be no higher than the expected price in the target for the alternatives, so trading success is likely.

| | | |
|---|---|---|
| descr. 2 = | if p₊(o) > t_{+,+}(o) | “Unable to trade now” |
| else | if p₊(o) > t_{e,+}(o) | “Able to trade now” |
| else | | “Eager to trade now” |

This second description indicates whether trading at this point is possible. In the first case, the no-risk price of the option is too high to trade—it exceeds the difference between the no-risk price of the alternatives and the no-risk price of the completions. In the second case, the price of the option is lower, but still such that if the no-risk price of the option is added to the no-risk price for completions in the target, the result is higher than the expected price in the target for the alternatives. In the third case, the addition of the no-risk price of the option is added to the no-risk price for completions in the target, the result will be no higher than the expected price in the target for the alternatives, making an immediate deal worthwhile.

Attitudes can be presented to the user in different ways in order to provide most appropriate support for their decisions. In one preferred approach for providing decision support to users, the full attitude displayed to the user is a list of the 3 options belonging to the seller that achieve the lowest values of q(o)pₑ(o)+bestₑ(Mₒ^{e}), and their corresponding option-attitudes, supplemented with the option-attitudes for the largest quantity available, and a quantity half-way through the total range (in that order). It will be understood that the form in which attitudes are presented is not central to any aspect of the present invention (and is not significant to the generation of tactics from attitudes for use by negotiating agents 3).

Negotiation Process—Tactics

The process of tactic selection is broken into two sub-processes, which are referred to as the basic module, and the appropriateness module. Both modules place weights (numbers between 0 and 1) on each of a set of possible fixed tactics that the negotiation agent might use: the weights are multiplied together, and the tactic with greatest total weight is chosen. The types of tactics are:

Alpha-Beta tactics specify two numbers, α and β. The new bid is given with respect to the preceding one, the last ask, and the most recent change to the ask, as shown here:

new bid=old bid+α×(change in ask)+β×(ask-bid).

Part of customisation will be to select constants α₀>1, 0<βₛₘₐₗₗ<β_{big}<1 for which suitable values might be 2, ⅕, ½, respectively.

The fixed alpha tactics Aⱼ, j=0,1,2,3,4 will be the 5 alpha-beta tactics with β=0, α={α₀,½(1+α₀),½,1,0} respectively.

The fixed beta tactics Bⱼ, j=0,1,2 will be the 3 alpha-beta tactics with α=0, β={0, βₛₘₐₗₗ, β_{big}) respectively.

Note that A₄=B₀.

The basic module determines appropriate tactic selections in the absence of historical information, and captures the pre-configuration and configuration information regarding which tactics are appropriate in which circumstances. The rationale behind tactic selection is that the value of the expected price relative to the expected-price-alternatives, govern the use of the α parameter; the β parameter is determined by “how far the seller has to go”: the normalized difference between the current ask and the expected price. If the change between the previous and current ask is non-zero, weight zero is assigned to B₁, B₂, and weights are assigned to the fixed alpha tactics Aⱼ according to the following algorithm:

1. Define

t₀=t_{-,e}(o)

t₁=½(t_{-,e}(o)+t_{e,e}(o)),

t₂=t_{e,e}(o),

t₃=½(t_{e,e}(o)+t_{+,e}(o)),

t₄=t_{+,e}(o).

2. Let n be the greatest index such that tₙ<pₑ(o), or −1 if no such n exists.

3. Define

$$S = \{ \begin{matrix}\begin{matrix} & if n = - 1 \\ \frac{{p}_{e} ( o ) - {t}_{n}}{{t}_{n + 1} - {t}_{n}} & if n = ∈ \{ 1 , … 4 \} \\ & if n = 4\end{matrix} \\ \end{matrix}$$

4. For j {0, . . . 4}, give each tactic Aⱼ weight e^{-μln+s-j}^{ⁱ}.

If the change between the previous and current ask is zero, weight zero is assigned to Aⱼ for j>0, and weights are assigned to the fixed beta tactics Bⱼ according the following algorithm:

1. Let

$$S = \{ \begin{matrix}\frac{{p}_{+} ( o ) - {p}_{e} ( o )}{{p}_{+} ( o ) - {p}_{-} ( o )} & if {p}_{+} ( o ) > {p}_{-} ( o ) \\ 0 & Otherwise\end{matrix}$$

2. If s<¼, assign weights 1, 0.5, 0.25 to B₀ B₁ and B₂ respectively;

3. If ¼≦s<¾, assign weights 0.5, 1, 0.5 to the beta tactics, and

4. If ¾≦2, assign weights 0.25, 0.5, 1.

The appropriateness module determines, on the basis of past experience, which tactics are expected to lead to good outcomes with a given seller. An important requirement for the appropriateness module is that the negotiation agent has a notion of time as measured in bidding rounds. A bidding round is an ask-bid pair.

For each seller there is a set of weights for each fixed tactic, which are determined in the following way:

1. When the negotiation agent is installed, all weights are set to 1. In a given run, after the exchange of Request-For-Quote, and initial bids and asks, the negotiation agent maintains an integer variable, roundCount, which is initialised to 0, and increases by 1 at the end of each round, and a bid-ask pair, a₀, bₒ which are initialised by the following:

2. At the beginning of each round, a comparison is made between the tactic selected in this round and that selected in the previous. If they are the same, no further action is taken.

3. If they differ (or if the round is the first), then the following two steps are followed:

(a) If roundCount is greater than some fixed threshold roundCountₘᵢₙ (e.g. 10), then the weight w is calculated using the ask in the previous round, a₁, as

$$w = \frac{{a}_{0} - {a}_{1}}{{a}_{0} - {b}_{0}}$$

The appropriateness weight w(T) for whichever tactic T was used in the last round is then updated using a learning constant γε(0,1) (e.g. 0.2) according to the formula w(T):=λw+(1−λ)w(T). The larger the learning constant γ, the quicker the appropriateness index is adjusted by new bid histories. At the end of this adjustment step, the weights are saved to a suitable database for re-use next time.

(b) The roundCount variable is set to 0, aₒ is set to be the ask from the previous round, bₒ is set to be the bid from the previous round.

End of Negotiation

The purchaser continues trading until the completion condition is met 17 or until agents have withdrawn from all negotiations 18. In a preferred embodiment the completion condition can be set to be when the difference between the worst-case and expected (average) case prices is less than a pre-defined (small) proportion, ε of the worst-case:

best₊(M)−bestₑ(M)<ε·best₊(M).

However, it will be appreciated that other appropriate completion conditions could be adopted instead, which would be apparent to the skilled person.

When the completion condition is reached, any remaining trading 19—for example, instructions for dealing with direct sellers, the results of auctions having concluded—takes place, and the history data store 5 is updated with information relating to the negotiation or negotiations concerned.

Although the embodiments of the invention described with reference to the drawings comprise computer apparatus and processes performed in computer apparatus, the invention, as previously indicated, also extends to computer programs, particularly computer programs on or in a carrier, adapted for putting the invention into practice. The program may be in the form of source code, object code, a code intermediate source and object code such as in partially compiled form, or in any other form suitable for use in the implementation of the processes according to the invention. The carrier be any entity or device capable of carrying the program. For example, the carrier may comprise a storage medium, such as ROM, for example a CD ROM or a semiconductor ROM, or a magnetic recording medium, for example a floppy disc or hard disk. Further, the carrier may be a transmissible carrier such as an electrical or optical signal which may be conveyed via electrical or optical cable or by radio or other means. When the program is embodied in a signal which may be conveyed directly by a cable or other device or means, the carrier may be constituted by such cable or other device or means. Alternatively, the carrier may be an integrated circuit in which the program is embedded, the integrated circuit being adapted for performing, or for use in the performance of, the relevant processes.

Although the invention has been shown and described with respect to a best mode embodiment thereof, it should be understood by those skilled in the art that the foregoing and various other changes, omissions and additions in the form and detail thereof may be made therein without departing from the scope of the invention as claimed.

1. A method of automatic negotiation with multiple sellers for a first quantity of a good or service, the method comprising:
a. identifying a plurality of sellers offering quantities of the good or service;
b. automatically creating a plurality of permutations each comprising an ordering of the sellers in the plurality of sellers;
c. for each said permutation, automatically performing the substeps of initialising a cumulative total, allocating to the first seller in the permutation a whole of the quantity offered by that seller or a part of the quantity sufficient to make the cumulative total equal to the first quantity, adding the quantity allocated to the first seller to the cumulative total, and continuing said allocating and adding substeps for each successive seller in the permutation until the cumulative total is equal to the first quantity, whereupon the allocation of quantities of the good or service to each seller in the permutation forms a bundle for that permutation; and
d. negotiating with at least one of said plurality of sellers in order to buy one of the bundles.

2. A method as claimed in claim 1, wherein the step of automatically creating the plurality of permutations comprises creating all possible orderings of the plurality of sellers.

3. A method as claimed in claim 2, wherein if the bundle of any permutation duplicates the bundle of any other permutation, only one of the alternative bundles is used in negotiation.

4. A method as claimed in claim 1, wherein an expected price is automatically determined for each seller, and wherein a set of bundles is pruned to exclude bundles for which the expected price of the bundle is relatively high.

5. A method as claimed in claim 4, wherein bundles whose expected price is greater than a maximum price set by a buyer are excluded.

6. A method as claimed in claim 1, wherein the plurality of sellers include auctions.

7. A method as claimed in claim 6, wherein the plurality of sellers also includes direct sellers.

8. An automated negotiation system, comprising a processor and a communications interface, wherein the processor is programmed to on identifying a plurality of sellers for a quantity of a good or service, create a plurality of permutations each comprising an ordering of the sellers in the plurality of sellers; for each of the permutations, create an allocation of the quantity between the sellers wherein as much is allocated to the first seller in the ordering as can be sold by that seller and consequently as much of the remainder is allocated to the second seller in the ordering as can be sold by that seller and so on for each subsequent seller until all the quantity has been allocated, each such allocation creating a bundle for that permutation, wherein the processor is adapted to negotiate through the communications interface with at least some of the plurality of sellers in order to buy one of said bundles.

9. A data carrier having recorded thereon program code which when executed by a processor, causes the processor to negotiate for a quantity of a good or service with an identified plurality of sellers for said good or service by creating a plurality of permutations each comprising an ordering of the sellers in the plurality of sellers; for each of the permutations, creating an allocation of the quantity between the sellers wherein as much is allocated to the first seller in the ordering as can be sold by that seller and consequently as much of the remainder is allocated to the second seller in the ordering as can be sold by that seller and so on for each subsequent seller until all the quantity has been allocated, each such allocation creating a bundle for that permutation, and negotiating with at least some of the plurality of sellers in order to buy one of said bundles.

10. A signal having data encoded thereon comprising program code which when executed by a processor, causes the processor to negotiate for a quantity of a good or service with an identified plurality of sellers for said good or service by creating a plurality of permutations each comprising an ordering of the sellers in the plurality of sellers; for each of the permutations, creating an allocation of the quantity between the sellers wherein as much is allocated to the first seller in the ordering as can be sold by that seller and consequently as much of the remainder is allocated to the second seller in the ordering as can be sold by that seller and so on for each subsequent seller until all the quantity has been allocated, each such allocation creating a bundle for that permutation, and negotiating with at least some of the plurality of sellers in order to buy one of said bundles.
